(19) United States
(12) Patent Application Publication
(10) Pub. No.: US 2024/0252855 A1
(43) Pub. Date: Aug. 1, 2024

(54) RETRACTABLE LIFELINE APPARATUS AND METHOD OF USING THE SAME

(71) Applicant: Honeywell Safety Products USA, Inc., Charlotte, NC (US)

(72) Inventors: Juan Carlos Adib Audelo Navarro, Mexico City (MX); José Antonio Fosado Rodríguez, Mexico City (MX); Fatima Sierra, San Luis Potosi (MX); Luis Adolfo Guzman, Tijuana (MX)

(21) Appl. No.: 18/160,233

(22) Filed: Jan. 26, 2023

(51) Int. Cl. A62B 35/00

(52) U.S. Cl. CPC A62B 35/0093; A62B 35/005; A62B 35/0068

(57) ABSTRACT

Various embodiments are directed to a lifeline apparatus and method of using the same. In various embodiments, the lifeline apparatus comprises a spool lock assembly selectively configurable between a locked configuration and an unlocked configuration to facilitate selective deployment of a lifeline from within a housing, the spool lock assembly comprising: a latch plate configurable between a nominal position and an actuated position; a lock arm engaged with the latch plate and configured for arrangement between engaged and disengaged positions based on a latch plate position, wherein the engaged position of the lock arm is defined the lock arm being positioned to prevent the selective deployment of the lifeline by restricting rotation of one or more components operatively connected to the lifeline; wherein the configuration of the spool lock assembly between the locked and unlocked configurations is defined by the latch plate position between the nominal and actuated positions.

### FIELD OF THE INVENTION

Various embodiments described herein relate generally to retractable lifeline apparatuses for providing a linear anchor point to which a user may be operatively secured in order to mitigate potential fall risks.

### BACKGROUND

Retractable lifeline systems are used today to mitigate the risk of serious personal injury that often accompanies working at height, such as, for example, on a roof. In particular, such systems often include a cable anchored on each opposite end and arranged on the elevated work surface so as to generally define a travel path about the elevated work surface. In some instances, a retractable lifeline may be deployed between anchors to define a linear anchor point. To avoid falling from the elevated surface, a worker tasked with walking about the elevated surface, often equipped with a harness or similar safety device operably secured to, for example, an attachment hook, may be tethered to the linear anchor point.

Applicant has identified many technical challenges and difficulties associated with retractable lifeline apparatuses used to provide linear anchor points. Through applied effort, ingenuity, and innovation, Applicant has solved problems related to these lifeline apparatuses by developing solutions embodied in the present disclosure, which are described in detail below.

### BRIEF SUMMARY

Various embodiments are directed to lifeline apparatuses and methods of using the same. In various embodiments, a lifeline apparatus may comprise a housing defining an interior portion configured for storing at least a portion of a retractable lifeline therein; a spool lock assembly selectively configurable between a locked configuration and an unlocked configuration to facilitate a selective deployment of at least a portion of the retractable lifeline from within the housing, the spool lock assembly comprising: a latch plate configurable between a nominal position and an actuated position based at least in part on a user interaction with at least a portion of the latch plate; a lock arm at least partially engaged with the latch plate and configured for arrangement between an engaged position and a disengaged position based at least in part on a position of the latch plate, wherein the engaged position of the lock arm is defined by the lock arm being positioned to prevent the selective deployment of the lifeline from within the housing by restricting rotation of one or more components operatively connected to the at least a portion of the retractable lifeline; wherein the configuration of the spool lock assembly between the locked configuration and the unlocked configuration is defined at least in part by the position of the latch plate between the nominal position and the actuated position.

In various embodiments, the latch plate may be hingedly connected to a latch hinge pin such that a movement of the latch plate between the nominal position and the actuated position is defined at least in part by a rotation of the latch plate about a central axis of the latch hinge pin. In certain embodiments, the latch plate may be physically engaged with the lock arm that the rotation of the latch plate between the nominal position and the actuated position corresponds to a respective rotation of the lock arm about a lock arm hinge to which the lock arm is pivotably connected. In various embodiments, the locked configuration of the spool lock assembly may be defined at least in part by the lock arm being arranged in the engaged position. In various embodiments, the spool lock assembly may further comprise a tray defined by an outer sidewall provided on an exterior surface of the housing and an interior tray portion defined within the outer sidewall, wherein the nominal position of the latch plate is defined at least in part by an exterior plate surface of the latch plate being arranged in an at least substantially flush configuration with at least a portion of the tray. In various embodiments, the spool lock assembly may be configured such that, upon being configured in the unlocked position, the spool lock assembly is held in the unlocked configuration until a threshold locking force sufficient to cause the latch plate to be moved from the actuated position towards the nominal position is received at the latch plate.

In various embodiments, the spool lock assembly may comprise a plurality of corresponding interface features configured for engagement with one another to at least partially secure the latch plate in one or more directions relative to the lock arm to facilitate a retention of the latch plate and the lock arm in the actuated position and the disengaged position, respectively. In certain embodiments, the plurality of corresponding interface features may comprise an interface protrusion feature defined by the latch plate and an interface cavity feature defined by the lock arm, wherein, upon the spool lock assembly being configured in an unlocked configuration, the interface protrusion feature and the interface cavity feature physically contact one another such that the interface cavity feature receives at least a portion of the interface protrusion feature therein. Further, in certain embodiments, the interface protrusion feature may be defined by a protrusion extending from an arm engagement tab of the latch plate, and the interface cavity feature is defined by a recessed groove provided along a first arm end defined by the lock arm, the recessed groove being configured to receive at least a portion of the protrusion therein to at least partially restrict a relative movement of the arm engagement tab with respect to the first arm end in one or more directions.

In certain embodiments, the lifeline apparatus may further comprise one or more ball plungers to configured to facilitate a retention of the latch plate in one or more of the nominal position and the actuated position by engaging a surface of the latch plate to cause an interference between the latch plate and an adjacent surface of a tray of the spool lock assembly that operably resists a rotational movement of the latch plate away from one or more of the nominal position and the actuated position. Further, in certain embodiments, the latch plate may define one or more indentions provided at respective lateral side surfaces thereof is configured such that, when the latch plate is positioned in one or more of the nominal position and the actuated position, the latch plate is configured to receive at least a portion of the one or more ball plungers within the one or more indentions, wherein the one or more ball plungers being at least partially disposed within the one or more indentions at least partially secures the latch plate relative to the adjacent surface of the tray to resist a relative movement of the latch plate away from the adjacent surface of the tray. Further still, in certain embodiments, the one or more ball plungers may comprise a first ball plunger disposed between a first lateral side surface of the latch plate and a first lateral side surface of the tray adjacent thereto, and a second ball plunger disposed between an opposing second lateral side surface of the latch plate and a second lateral side surface of the tray adjacent thereto, wherein the one or more indentions defined by the latch plate comprises a first indention provided along the first lateral side surface and configured to receive at least a portion of the first ball plunger therein when the latch plate is positioned in the actuated position, and a second indention provided along the second lateral side surface and configured to receive at least a portion of the second ball plunger therein when the latch plate is positioned in the actuated position.

In various embodiments, the spool lock assembly may further comprise a secondary safety mechanism that configured for selective arrangement in a locked position such that the spool lock assembly defines a secondary locking means for securing the latch plate in the nominal position In certain embodiments, the secondary safety mechanism may define a dynamic configuration relative to the latch plate, wherein the secondary safety mechanism is selectively configurable between the locked position and an unlocked position based at least in part on one or more movements of the secondary safety mechanism relative to the latch plate. Further, in certain embodiments, the spool lock assembly may be configured such that configuring the spool lock assembly in the unlocked configuration is defined by a dual-action unlocking operation. Further still, in certain embodiments, the dual-action unlocking operation may be defined by a first arrangement of the secondary safety mechanism in an unlocked position and a second arrangement of the latch plate in the actuated position.

In various embodiments, the spool lock assembly may further comprise a biasing spring engaged with the lock arm and configured to apply one or more bias forces to the lock arm to bias a rotation thereof towards the locked position. In certain embodiments, at least a portion of the lock arm may be in physical contact with an arm engagement tab provided along an underside of the latch plate such that a biased configuration of the lock arm causes the latch plate to be biased towards the nominal position. In various embodiments, the lifeline apparatus may further comprise a first fastener element fixedly secured to an exterior surface of the housing and a second fastener element attached to a distal end of the retractable lifeline. In various embodiments, the actuated position of the latch plate may be defined at least in part by at least a portion of the latch plate protruding outward in a direction at least partially away from an exterior surface of the housing.

### BRIEF DESCRIPTION OF THE DRAWINGS

Reference will now be made to the accompanying drawings, which are not necessarily drawn to scale, and wherein:

FIG. 1 illustrates a perspective view of an exemplary lifeline apparatus in accordance with various embodiments described herein;

FIGS. 2A and 2B illustrate schematic views of exemplary lifeline apparatuses defining unlocked configurations in accordance with various embodiments described herein;

FIGS. 3A and 3B illustrate various views of a latch assembly of an exemplary lifeline apparatus in accordance with various embodiments described herein;

FIGS. 4A and 4B illustrate various views of a latch assembly of an exemplary lifeline apparatus in accordance with various embodiments described herein;

FIGS. 5A and 5B illustrate side cross-sectional views of an exemplary spool lock assembly in accordance with various embodiments described herein; and

FIGS. 6A and 6B illustrate various views of an exemplary spool lock assembly in accordance with various embodiments described herein; and

FIGS. 7A and 7B illustrate side perspective views of an exemplary lifeline apparatus in an example fall condition in accordance with various embodiments described herein.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

It should be understood at the outset that although illustrative implementations of one or more aspects are illustrated below, the disclosed assemblies, systems, and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents. While values for dimensions of various elements are disclosed, the drawings may not be to scale.

The words “example,” or “exemplary,” when used herein, are intended to mean “serving as an example, instance, or illustration.” Any implementation described herein as an “example” or “exemplary embodiment” is not necessarily preferred or advantageous over other implementations.

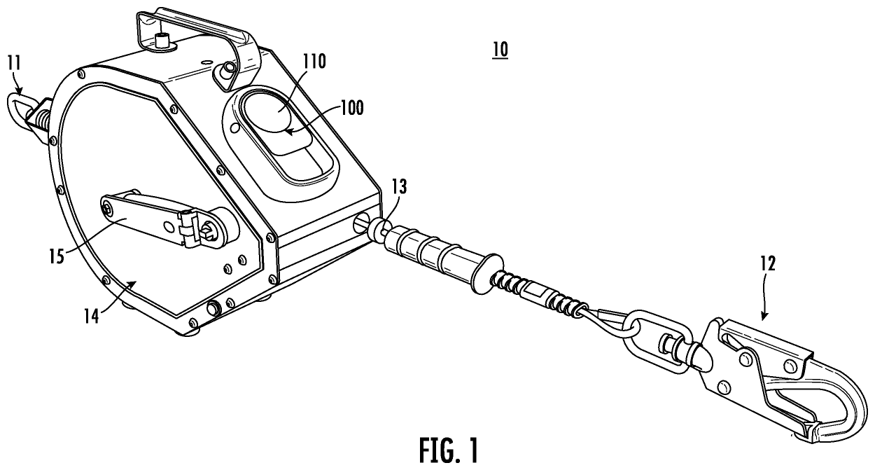

FIG. 1 illustrates a perspective view of an exemplary lifeline apparatus in accordance with various embodiments described herein. In particular, FIG. 1 illustrates an exemplary lifeline apparatus 10 configured to provide a linear anchor point between two at least two locking points using a retractable lifeline 13 configured to be selectively controlled using a spool lock assembly 100. As illustrated, an exemplary lifeline apparatus 10 may comprise a first lifeline fastener element 11 defining a first end of the lifeline apparatus 10 and a second lifeline fastener element 12 defining an opposing second end of the lifeline apparatus 10. The lifeline apparatus 10 may comprise a retractable lifeline 13 that may be at least partially stored in a spooled configuration within a housing 14. At least a portion of the retractable lifeline 13 may be selectively deployed from the spool defined within the housing 14 by pulling a dynamic end of the retractable lifeline 13 (e.g., the second fastener element 12) in a direction away from the housing 14 in order to cause at least a portion of the spooled lifeline 13 within the housing 14 to be unwound (e.g., via a rotation of a pinion configured to defined the rotation of the spool) such that an additional length of the lifeline 13 is deployed from the housing 14 for use in as part of a linear anchor point.

In various embodiments, the exemplary lifeline apparatus 10 may be configured to provide an operable linear anchor point to which various personal protection equipment (PPE) being worn by and/or operatively connected to a user may be dynamically attached to secure the user relative to the anchor point and allowing the user to move between various locations defined along the length of the linear anchor point while remaining securely anchored relative thereto. For example, the first fastener element 11 of the lifeline apparatus 10 may be secured in a fixed position to an exterior surface of the housing 14. Further, the second fastener element 12 may be secured to the end of the retractable lifeline 13 such that as the lifeline is selectively retracted and/or deployed relative to the housing 14, the second fastener element 12 may be moved relative to the housing 14. In various embodiments, the first fastener element 11 may be configured to be secured, fastened and/or otherwise at least temporarily connected to a first anchor (e.g., a structurally rigid fastener element capable of engaging the first fastener element 11 to define and anchored attachment of the lifeline apparatus 10 thereto). Further, the second fastener element 12 may be configured to be secured, fastened and/or otherwise at least temporarily connected to a second anchor (e.g., a structurally rigid fastener element, structural component, and/or the like to which the second end of the lifeline 13 may be secured using the second fastener element 12). As illustrated, the first fastener element 11 may be disposed on the opposite end of the housing 14 relative to the opening through which the lifeline 13 extends from the spool within the housing 14 to the exterior environment. For example, in an exemplary configuration wherein the first fastener element 11 is secured to a first anchor, a second fastener element 12 is secured to a second anchor, and the lifeline 13 is arranged in a fully deployed configuration extending therebetween, the housing 14 may define a position in between the first fastener element 11 and the second fastener element 12.

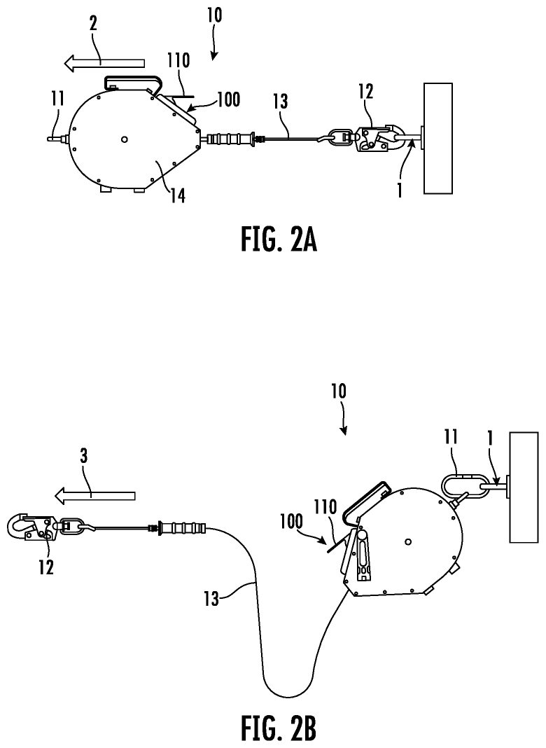

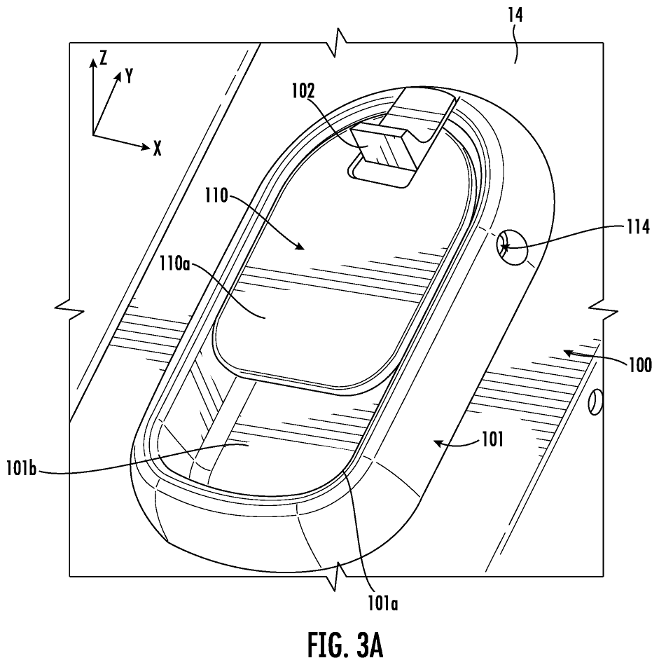

In various embodiments, the lifeline apparatus 10 may comprise a spool lock assembly 100 disposed at least partially along an exterior surface of the housing 14 that is configurable between a locked configuration and an unlocked configuration to facilitate a user-initiated transition between a lifeline 13 being locked in an operable configuration (e.g., prevented from further retraction and/or deployment relative to the housing 14) and unlocked for selective retraction and/or deployment. For example, the spool look assembly 100 may be arranged in an at least substantially flush configuration along an exterior surface of the housing 14 such that the spool lock assembly 100 is accessible to a user for interaction therewith. In various embodiments, a user may interact with the spool lock assembly 100 to reconfigure the spool lock assembly 100 from a locked configuration to an unlocked configuration, such as, for example, in order to deploy at least a portion of the lifeline 13 spooled within the housing 14, by repositioning a latch plate 110 from a nominal position—as illustrated in FIG. 1—to an actuated position—as illustrated in the exemplary embodiment shown in FIGS. 2A and 2B. For example, as described herein, the latch plate 110 of an exemplary spool lock assembly 100 may define a hinged connection such that actuating the latch panel is defined by user-driven rotation of the latch panel 110 about a latch hinge pin (not shown).

As illustrated in FIGS. 2A and 2B, the latch panel 110 of an exemplary spool lock assembly 100 may be selectively actuated (e.g., moved to an actuated position) in order to configure the spool lock assembly 100 in an unlocked configuration such that the lifeline 13 may be selectively deployed from the spool within the housing 14 of the lifeline apparatus 10. The exemplary lifeline apparatus 10 may define a flexibly operable configuration in which the lifeline apparatus 10 is configured to enable execution of a lifeline 13 deployment (e.g., and/or retraction or stowing) in a plurality of distinct means. As an illustrative example, the exemplary lifeline apparatus 10 illustrated in FIG. 2A is anchored to a first anchor 1 (e.g., a wall and/or a fastener rigidly secured thereto) using the second fastener element 12 provided on the dynamic end of the retractable lifeline 13. In such an exemplary configuration, the spool lock assembly 100 may be selectively configured in the unlocked configuration by lifting the latch panel 110 to an actuated position, as shown. As described herein, upon the spool lock assembly 100 being configured in the unlocked configuration, the lock arm (not shown) may disengage with a pinion (not shown) of the lifeline apparatus 10 such that the pinion and the spooled lifeline operatively connected thereto may freely rotate (e.g., unwind) to enable the deployment of the lifeline 13 relative from within the housing 14. For example, in various embodiments wherein the second fastener element 12 provided at the dynamic (e.g., deployable) end of the lifeline 13 is anchored to an anchor point, a user may execute a deployment of the lifeline 13 by carrying the housing 14 of the lifeline apparatus 10 in a direction 2 at least substantially away from the first anchor 1, such as, for example, towards a second anchor, while the spool lock assembly 100 remains configured in the unlocked configuration. As described herein, the latch plate 110 may be configured to remain in the actuated position to hold the spool lock assembly 100 in an unlocked configuration until one or more external forces (e.g., a subsequent user interaction therewith, an impact force acting on the latch plate 110, and/or the like) pushes the latch plate 110 back towards the nominal position. As such, the lifeline apparatus 10 may be operable for continuous deployment of the lifeline 13 as the user walks in the direction 2 away from the first anchor 1 based at least in part on the spool lock assembly 100 being configured to maintain the actuated position of the latch plate 110 without requiring further and/or continuous user interaction therewith. The lifeline 13 may continue to be deployed as the user carries the housing 14 in the direction 2 such that the length of the lifeline 13 deployed from the housing 14 is provided in between the housing 14 and the anchor 1. In various embodiments, upon the housing 14 being carried to a second anchor such that the first fastener element 11 is anchored to the second anchor, the lifeline apparatus 10 may be further operated by repositioning the latch plate 110 of the spool lock assembly 100 from the actuated position to a nominal position, thereby reconfiguring the spool lock assembly 100 in a locked configuration. A user may further use a crank handle (e.g., the crank handle 15 illustrated in the exemplary embodiment depicted in FIG. 1) to tension the lifeline 13 locked between the first anchor 1 and the second anchor (not shown) in order to provide a linear anchor point.

As a further illustrative example, FIG. 2B illustrates the exemplary lifeline apparatus 10 in a configuration wherein the lifeline apparatus 10 is anchored to the first anchor 1 using the first fastener element 11 that is fixed to an exterior surface of the housing 14 that faces in a direction at least substantially away from the opening through which the lifeline 13 passes during deployment and/or retraction thereof. In such an exemplary configuration, the latch panel 110 may be provided in an actuated position, as illustrated, to configure the spool lock assembly 100 in the unlocked configuration. In various embodiments wherein the first fastener element 11 attached to the housing 14 of the lifeline apparatus 10 is anchored to the first anchor 1, a user may execute a deployment of the lifeline 13 by carrying the second fastener element 12 provided at the dynamic (e.g., deployable) end of the retractable lifeline 13 in a direction 3 at least substantially away from the first anchor 1, such as, for example, towards a second anchor, while the spool lock assembly 100 remains configured in the unlocked configuration. As such, the lifeline apparatus 10 may be operable for continuous deployment of the lifeline 13 as the user carries the second fastener element 12 in the direction 3 to pull the lifeline 13 away from the housing 14 (e.g., and the first anchor 1) based at least in part on the spool lock assembly 100 being configured to maintain the actuated position of the latch plate 110 without requiring further and/or continuous user interaction therewith. In various embodiments, upon the second fastener element 12 being carried to a second anchor such that the second fastener element 12 may be anchored thereto, the lifeline apparatus 10 may be further operated by repositioning the latch plate 110 of the spool lock assembly 100 from the actuated position to the nominal position in order to reconfigure the spool lock assembly 100 to the locked configuration. As described above, a user may use a crank handle to tension the lifeline 13 anchored between the first anchor 1 and the second anchor (not shown) in order to provide a linear anchor point.

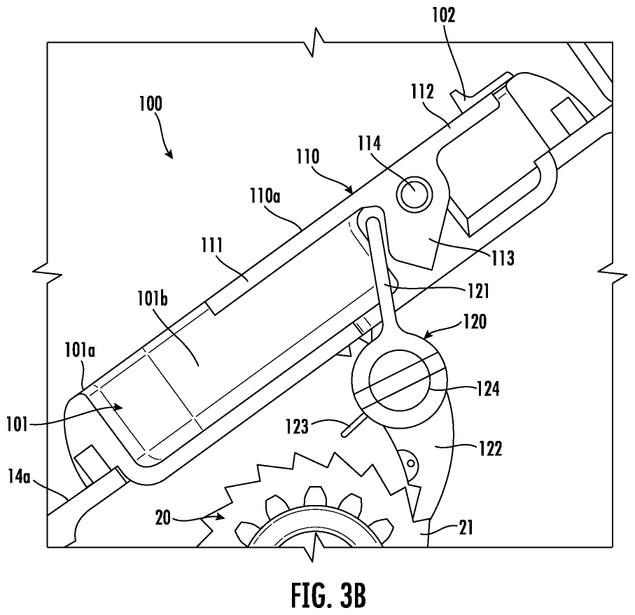

FIGS. 3A and 3B illustrate various views of a latch assembly of an exemplary lifeline apparatus. In particular, FIGS. 3A and 3B illustrate a perspective view and a cross-sectional view, respectively, of an exemplary spool lock assembly 100 in a locked configuration. As illustrated in FIGS. 3A and 3B, an exemplary spool lock assembly 100 may comprise a tray 101 disposed at an exterior surface of the housing 14 of an exemplary lifeline apparatus. The tray 101 may be configured for at least partially securing a latch plate 110 of the spool lock assembly 100 relative thereto such that the latch plate 110 is positioned along an exterior of the housing 14 and accessibly to a user for interaction therewith without opening and/or disassembling the housing 14. In various embodiments, the tray 101 may be defined at least in part by a raised outer sidewall 101a embodying an exterior ridge provided around the perimeter of the tray 101 that defines a ridge height extending (e.g., protruding) from the exterior housing surface 14a in an at least substantially outward direction away from the surface 14a to an uppermost edge of the outer sidewall 101a. For example, the outer sidewall 101a may define a raised configuration relative to the housing surface 14a. Further, the tray 101 may include an interior tray portion 101b defined within the outer sidewall 101a of the tray 101. For example, the interior tray portion 101b may embody an interior volume and/or a material recess (e.g., defined relative to the uppermost edge of the outer sidewall 101a) the be accessible to a user from outside the housing 14 to facilitate user interaction with the latch plate 110 secured relative to the tray 101.

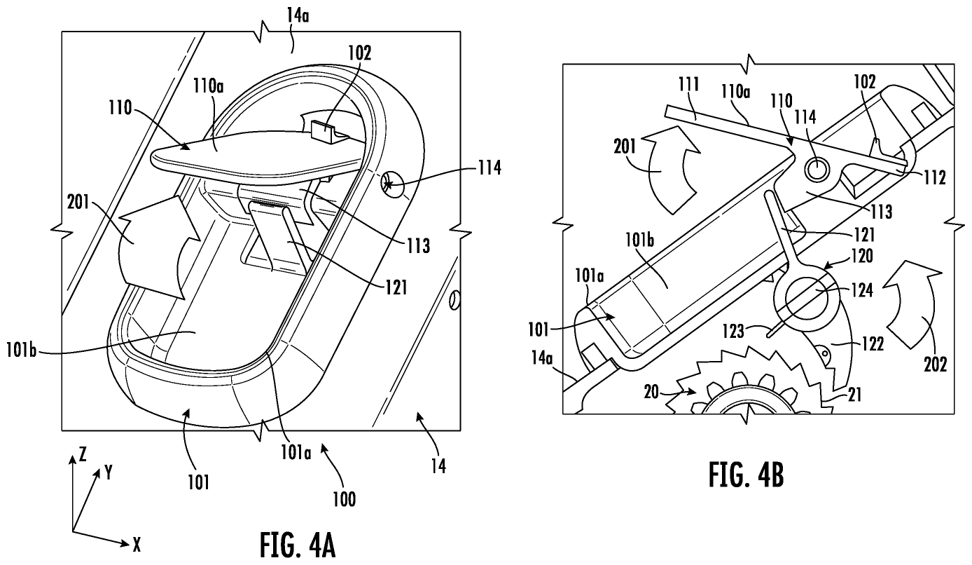

In various embodiments, an exemplary spool lock assembly 100 may comprise a latch plate 110 hingedly secured relative to the tray 101 and configured to be selectively moved (e.g., rotated) between a nominal position and an actuated position in order to configure the spool lock assembly 100 between a locked configuration and an unlocked configuration, respectively. FIGS. 3A and 3B illustrate the latch plate 110 of the exemplary spool lock assembly 100 in a nominal position corresponding to the spool lock assembly 100 defining a locked configuration, as described herein. As illustrated, the latch plate 110 may be hingedly connected to the tray 101 (e.g., the outer sidewall 101a) via a latch hinge pin 114 extending through the latch plate 110 in an at least substantially lateral direction (e.g., in the x-direction as defined in the exemplary orientation illustrated in FIG. 3A). The latch plate 110 may be rotated in either a first or opposing second rotation direction about an axis of rotation defined by the hinge axis of the latch hinge pin 114 between the nominal position—illustrated in FIGS. 3A and 3B—and the actuated position—shown in FIGS. 4A and 4B.

As illustrated in FIGS. 3A and 3B, the nominal position of the latch plate 110 may be defined at least in part by the latch plate 110 being positioned about the hinge pin 114 such that an exterior plate surface 110a of the latch plate 110 defines an at least substantially flush arrangement relative to the outer sidewall 101a (e.g., the uppermost edge thereof) of the tray 101. The exterior plate surface 110a of the latch plate 110 being at least substantially flush with the uppermost edge of the tray 101 in the nominal configuration minimizes the profile of the spool lock assembly 100 so as to reduce the risk of undesired and/or unexpected physical engagement therewith and minimize the physical damage caused by impacts or other forceful engagements with the lifeline apparatus. In the nominal position, the latch plate 110 may be configured to provide coverage over a first portion of the interior portion 101b of the tray 101b, while a second portion of the interior portion 101b remains uncovered such that the interior portion 101b and/or an underside 110b of the latch plate 110 may be accessed, such as, for example, for user interaction therewith, while the spool lock assembly 100 is in the locked configuration (e.g., when the latch plate 110 is in the nominal position).

In various embodiments, the latch plate 110 may be arranged such that an underside 110b of the latch plate (e.g., a surface opposite the exterior latch surface 110a) may be accessible to a user (e.g., a user's hand) via an opening defined by the interior portion 101b of the tray 101. As a non-limiting example described in further detail herein, the latch plate 110 may be configured such that a user may insert a hand and/or finger into a portion of the interior portion of 101b beneath the underside 110b of the latch plate 110 (e.g., underneath the first latch end 111) to enable the user to pull the first plate end 111 of the latch plate 110 in an at least partially outward direction (e.g., away from the exterior housing surface 14a). The spool lock assembly 100 may be configured such that pulling the first latch end 111 of the latch plate 110 away from the tray 101 and/or the exterior housing surface 14a of the lifeline apparatus may cause the latch plate 110 to rotate about the latch hinge pin 114 (e.g., in a clockwise direction as shown in the exemplary orientation illustrated in FIG. 3B) towards an activated position.

In various embodiments, the exemplary spool lock assembly 100 may further comprise a lock arm 120 configured for selective engagement with a pinion 20 provided within the housing 14 of the lifeline apparatus in order to secure the pinion 20 in a position (e.g., an angular position) such that the lifeline spooled within the housing 14 is locked from further deployment and/or retraction relative to the housing 14.

As illustrated, the lock arm hinge 124 may define an axis of rotation that is oriented in an at least substantially lateral direction (e.g., in the x-direction as defined in the exemplary orientation illustrated in FIG. 3B). The lock arm 120 may be rotated in either a first or opposing second rotation direction about an axis of rotation defined by the central axis of the lock arm hinge 124 between the engaged position—illustrated in FIG. 3B—and the disengaged position—shown in FIG. 4B. In various embodiments, the axis of rotation defined by the lock arm hinge 124 about which the lock arm 120 is rotated may be positioned in between a first arm portion 121 and a second arm portion 122 of the lock arm 120 such that a rotation of the lock arm 120 about the lock arm hinge 124 is defined by both the first and second arm ends 121, 122 of the lock arm being rotated about the axis of rotation in the same rotational direction. For example, the lock arm 120 of the exemplary spool lock assembly 100 may be configured to rotate about the lock arm hinge 124 between the engaged position, wherein a second arm end 122 (e.g., a lock arm pawl) of the lock arm 120 is physically engaged with a portion of the pinion 20 (e.g., a pinion tooth 21) to restrict and/or stop rotation of the pinion 20 such that the lifeline (not shown) operatively connected thereto is locked from movement in both the deployment and retraction directions, and a disengaged position in which the second arm end 122 of the lock arm 120 is disengaged (e.g., physically separated from) from the pinion 20 such that the pinion 20 is free to rotate in one or more directions to facilitate the deployment and/or retraction of the lifeline (not shown) operatively connected thereto. As such, the exemplary spool lock assembly 100 being configured in the locked configuration may be defined at least in part by the arrangement of the latch plate 110 in the nominal position and the corresponding arrangement of the lock arm 120 in the engaged position, as illustrated in FIGS. 3A and 3B.

In various embodiments, as illustrated, at least a portion of the lock arm 120 (e.g., a first arm end 121) may be operatively connected to (e.g., in physical contact with) the latch plate 110 such that the rotation of the lock arm 120 about the lock arm hinge 124 may be caused by, defined by, and/or, based at least in part on a corresponding rotation of the latch plate 110 between the nominal and actuated positions. For example, the spool lock assembly 100 may be configured such that at least a portion of the lock arm 120, such as, for example, the first arm end 121, remains engaged with an arm engagement tab 113 of the latch plate 110 throughout the range of rotation of the latch plate 110 (e.g., between the nominal and actuated positions). As described herein, the arm engagement tab 113 is defined by a portion of the latch plate 110 that protrudes from the underside 110b of the latch plate 110 and is configured to remain in physical contact with at least a portion of the lock arm 120 as the latch plate 110 is rotated in either a first or second rotational direction between the nominal and actuated positions. Further, in various embodiments, the lock arm 120 may be configured to maintain physical contact with the latch plate 110 (e.g., at the arm engagement tab 113) at the first arm end 121 such that the selective rotation of the latch plate 110 from the nominal position to the actuated position and/or from the actuated position to the nominal position causes the lock arm 120 to exhibit a corresponding rotation through a full range of rotational motion of the lock arm 120 that is defined between the engaged position and the disengaged position.

In various embodiments, the spool lock assembly 100 may further comprise a biasing spring 123 engaged with the lock arm 120 and configured to apply one or more forces to the lock arm 120 to bias the rotation thereof towards the engaged position, as illustrated in FIG. 3B. As a non-limiting example provided for illustrative purposes, the biasing spring 123 may be configured to bias the lock arm 120 towards a rotation about the lock arm hinge 124 in the counterclockwise direction, as defined in the exemplary orientation illustrated in FIG. 3B. In such an exemplary configuration, based at least in part on the operative connection of the latch plate 110 to the lock arm 120, the biasing forces of the biasing spring 123 may cause the lock arm 120 to apply an at least substantially continuous biasing force to the latch plate 110 that biases the rotation of the latch plate 110 towards the nominal position. Such an exemplary configuration facilitates the retention of the latch plate 110 in the nominal configuration to minimize unintentional actuations of the latch plate 110 caused by one or more unexpected external forces (e.g., impact forces) acting on the latch plate 110.

In various embodiments, the sensitivity of latch plate 110 (e.g., to one or more user interaction forces) may correspond to the configuration of the biasing spring 123 engaged with the lock arm 120. For example, in such an exemplary circumstance, the amount of force required for a user-generated pulling force to pull the first latch end 111 of a latch plate 110 in the nominal position away from the exterior housing surface 14a such that the latch plate 110 is rearranged to an actuated position, as described herein, may be configured and/or calibrated by adjusting the configuration of the biasing spring 123. Further, as described in further detail herein, the spool lock assembly 100 may be configured such that the retention forces defined by one or more retention features of the spool lock assembly 100 (e.g., an interface protrusion feature of the lock plate 110 that is engaged with an interface cavity feature of the lock arm 120, one or more ball plungers defining interference between the latch plate 110 and the tray 101, and/or the like) may at least substantially counteract the biasing force defined by the biasing spring 123 in order to facilitate the retention of the latch plate 110 in the actuated position.

In various embodiments, the spool lock assembly 100 may further comprise a secondary safety mechanism 102 defining an independent secondary unlocking operation that must be executed in order for the spool lock assembly 100 to be reconfigured from a locked configuration to an unlocked configuration. In various embodiments, the secondary safety mechanism 102 may be is dynamically attached relative to the latch plate 110 and selectively configurable in a locked position to secure the spool lock assembly 100 in the locked configuration by preventing the latch plate 110 from being actuated away from the nominal position. In various embodiments, the secondary safety mechanism 102 may define a dynamic configuration relative to the latch plate 110, wherein the secondary safety mechanism 102 is selectively configurable between a locked position that prevents the latch plate 110 from being actuated, as illustrated in FIGS. 3A and 3B, and an unlocked position in which the latch plate 110 is capable of being actuated (e.g., rotated from the nominal position to the actuated position) to reconfigure the spool lock assembly 100 to the unlocked configuration.

For example, the secondary safety mechanism 102 may define a slidable switch that is configured for selective arrangement in a locked position defined by the secondary safety mechanism 102 physically abutting against a portion of the tray 101 (e.g., an uppermost edge of the outer sidewall 101a) to prevent the latch plate 110 from rotating further relative to the tray 101 in a corresponding rotational direction. As an illustrative example, FIGS. 3A and 3B show the exemplary spool lock assembly 100 with a secondary safety mechanism 102 in a locked position defined by a simultaneous engagement of the secondary safety mechanism 102 with the second plate end 112 of the latch plate 110 and an adjacent portion of the uppermost edge of the tray outer sidewall 101a. In such an exemplary configuration, the secondary safety mechanism 102 embodies a physical obstacle that restricts the rotation of the latch plate 110 towards the actuated position to operably function as an independently controllable safety button that must be unlocked in order for the spool lock assembly 100 to be capable of actuation. That is, the exemplary spool lock assembly 100 comprising the secondary safety mechanism 102 may define a dual-action unlocking operation in which the spool lock assembly 100 is unlocked (e.g., for deployment of the lifeline) by first unlocking the secondary safety mechanism 102 and, subsequently, actuating the latch plate 110 to cause a movement of the lock arm 120 to the disengaged position such that pinion 20 may be freely rotated to deploy and/or retract the lifeline.

In various embodiments, the secondary safety mechanism 102 may be configured such that the unlocked position thereof is defined by the secondary safety mechanism 102 being disengaged from the tray 101 such that the latch plate 110 is free to be actuated from the nominal position to the actuated position without the secondary safety mechanism 102 interfering with and/or otherwise limiting the rotational movement of the latch plate 110. As a non-limiting example provided for illustrative purposes, the exemplary spool lock assembly 100 illustrated in FIGS. 4A and 4B comprises a secondary safety mechanism 102 that is provided in an unlocked position. FIGS. 4A and 4B illustrate various views of a latch assembly of an exemplary lifeline apparatus. In particular, FIGS. 4A and 4B illustrate a perspective view and a cross-sectional view, respectively, of an exemplary spool lock assembly 100 in an unlocked configuration.

The latch plate 110 of the exemplary spool lock assembly 100 illustrated in FIGS. 4A and 4B is shown in an actuated position that corresponds to the spool lock assembly 100 being configured in an unlocked configuration, as described herein. In various embodiments, the spool lock assembly 100 may be configured to be selectively reconfigured to the unlocked configuration based at least in part on a user interaction with the latch plate 110 that causes the latch plate 110 to be rotated from the nominal position to the actuated position. For example, the spool lock assembly 100 may be configured such that a user may apply a pulling force and/or a pushing force to an underside 110b of the first plate end 111 of the latch plate 110 in an outward direction at least substantially away from the exterior housing surface 14a in order to cause a rotation of the latch plate 110 about the latch hinge pin 114 in the first rotational direction 201 (e.g., clockwise about the hinge axis as defined by the exemplary orientation illustrated in FIGS. 4A and 4B). As illustrated, such a rotation of the latch plate 110 in the first rotational direction 201 defined may be defined by a movement (e.g., a rotation) of at least a portion of the first plate end 111 away from the interior portion 101b of the tray 101, and a corresponding movement (e.g., a rotation) of the second plate end 112 at least partially toward the interior portion 101b of the tray 101. For example, in various embodiments, the actuated position of the latch plate 110 may be defined by the latch plate 110 being rotated about the latch hinge pin 114 such that at least a portion thereof (e.g., the first plate end 111) is disposed at an outermost position away from the exterior housing surface 14a of the housing 14. In particular, the actuated position of the latch plate 110 may be defined, at least in part, by the first plate end 111 extending in an at least partially outward direction beyond a plane defined by the uppermost edge of the outer sidewall 101a of the tray 101 to operably embody a plate element protruding in an outward direction away from the housing 14 of the lifeline apparatus.

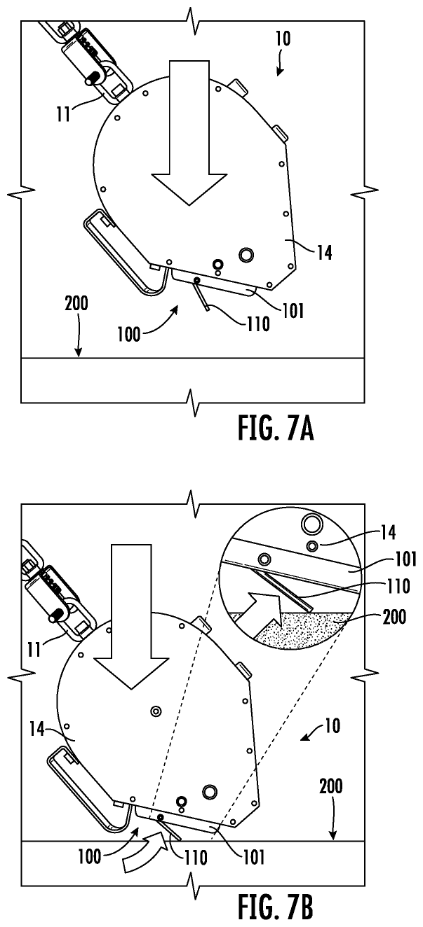

As illustrated in FIGS. 7A and 7B, an exemplary spool lock assembly 100 may be arranged about the housing 14 such that, in an exemplary circumstance wherein the lifeline apparatus 10 experiences a fall condition defined by the housing 14 falling from an installed position to a ground surface 200 there below, the exemplary lifeline apparatus is configured to initially contact the ground surface 200 at the portion of the actuated latch plate 110 extending outward beyond the exterior housing surface 14a. In such an exemplary configuration, the spool lock assembly 100 may be configured to automatically lock the position of the lifeline by utilizing the impact forces imparted from the ground surface 200 on the latch plate 110 in the actuated position to force the latch plate 110 to rotate into a nominal position such that the spool lock assembly 100 is reconfigured to the locked position with minimal user interaction (e.g., no user interaction).

Further, the rotation of the latch plate 110 in the first rotational direction 201 from the nominal position described above to the actuated position illustrated in FIGS. 4A and 4B may be defined by a corresponding rotation of the arm engagement tab 113 about the latch hinge pin 114 (e.g., in the first rotational direction 201) that results in the arm engagement tab 113 imparting a lateral pushing force on the portion of the lock arm 120 engaged therewith (e.g., the first arm end 211). In such an exemplary circumstance, based at least in part on the hinged configuration of the lock arm 120, the lateral pushing force imparted on the first arm end 211 from the arm engagement tab 113 of the latch plate 110 may cause a non-lateral torque and/or a moment to be imparted on the lock arm 120 in a second rotational direction 202 defined about the lock arm hinge 214 (e.g., counterclockwise about the hinge axis as defined by the exemplary orientation illustrated in FIGS. 4A and 4B). As illustrated, the second rotational direction 202 may embody the opposite rotational direction of the first rotational direction 201 defining the rotation of the latch plate 110.

In various embodiments, the spool lock assembly 100 may be configured such that the latch plate 110 and the lock arm 120 may be rotated in the first and second rotational directions 201, 202, respectively, upon a force (e.g., a user-generated force) being applied to the first plate end 111 of the latch plate 110 that is sufficient to result in the non-linear torque and/or moment imparted on the lock arm 120 by the arm engagement tab 113 being greater than the opposing non-linear torque and/or moment generated by the biasing spring 123 biasing force acting on the lock arm 120.

As illustrated, the positioning of the latch plate 110 in the actuated position may correspond to the lock arm 120 being arranged in the disengaged position. For example, the rotation of the lock arm 120 in the second rotational direction 202 may cause the second arm end 122 of the lock arm 120 to move in a direction at least partially away from the pinion 20 such that the lock arm 120 disengages the pinion 20. In such an exemplary configuration, the pinion 20 may be configured to rotate about a corresponding axis without interference from the spool lock assembly 100 (e.g., the lock arm 120) to facilitate a deployment and/or retraction of the lifeline spooled within the housing 14 of the exemplary lifeline apparatus. As such, the exemplary spool lock assembly 100 being configured in the unlocked configuration may be defined at least in part by the arrangement of the latch plate 110 in the actuated position and the corresponding arrangement of the lock arm 120 in the disengaged position, as illustrated in FIGS. 4A and 4B.

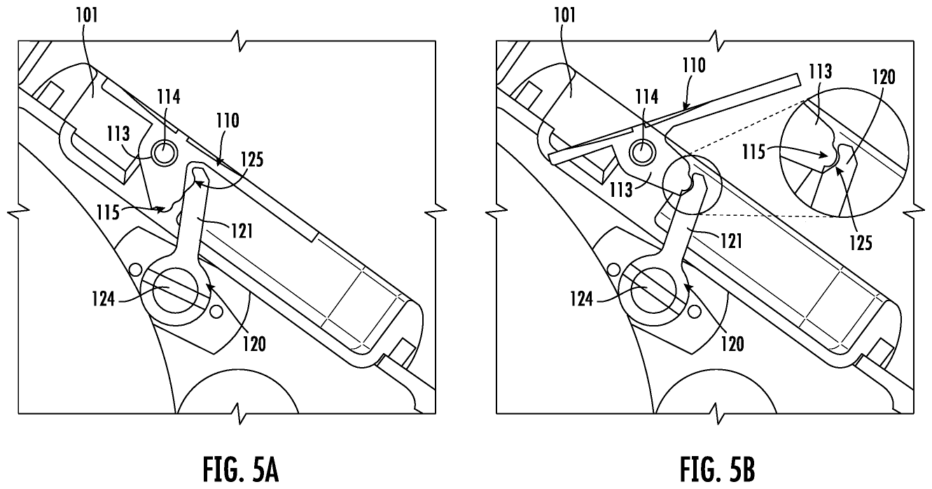

FIGS. 5A and 5B illustrate side cross-sectional views of an exemplary spool lock assembly in accordance with various embodiments described herein. In particular, FIGS. 5A and 5B illustrate an exemplary spool lock assembly 100 in a locked configuration and an unlocked configuration, respectively. As illustrated, the latch plate 110 and the lock arm 120 of an exemplary spool lock assembly 100 may define a pair of corresponding interface features configured to engage one another to facilitate a retention of the spool lock assembly 100 in an unlocked configuration until one or more external forces (e.g., impact forces, user interaction forces, and/or the like) initiates a reconfiguration of the spool lock assembly 100 towards the locked configuration. In various embodiments, as illustrated, the latch plate 110 of an exemplary spool lock assembly 100 may comprise an interface protrusion feature 115 defined by a protrusion, bump, and/or the like that is provided along the arm engagement tab 113 of the latch plate 110 such that the interface protrusion feature 115 physically contacts an adjacent portion of the lock arm 120 when the latch plate 110 is in the actuated position. Further, in various embodiments, the lock arm 120 may comprise an interface cavity feature 125 that defines a concave groove, recess, indention, and/or the like provided along the first arm end 121 of the lock arm 120 such that the interface cavity feature 125 is configured to physically contact an adjacent portion of the latch plate 110 when the lock arm 120 is in the disengaged position. In various embodiments, the interface protrusion feature 115 and the interface cavity feature 125 may be configured such that, upon the spool lock assembly 100 being arranged in the unlocked position wherein the latch plate 110 is in the actuated position and the lock arm 120 is in the disengaged position, the engagement between the interface protrusion feature 115 and the interface cavity feature 125 functions to secure the position of the latch plate 110 and the lock arm 120 relative to one another in order to at least temporarily hold the spool lock assembly 100 in the unlocked configuration.

As illustrated, in various embodiments, the latch plate 110 may have an interface protrusion feature 115 positioned along at least a portion of the arm engagement tab 113, and the lock arm 120 may have an interface cavity feature 125 defined in a corresponding position at least substantially adjacent the first arm end 121. In various embodiments, the interface protrusion feature 115 and the interface cavity feature 125 may define corresponding configurations such that the bump defined by the interface protrusion feature 115 may be at least partially received within the groove defined by the interface cavity feature 125. That is, in various embodiments, the interface protrusion feature 115 and the interface cavity feature 125 may define a male/female configuration wherein, when the spool lock assembly 100 is in the unlocked configuration, the arm engagement tab 113 of the latch plate 110 is moved relative to the lock arm 120 such that the interface protrusion feature 115 extends at least partially into the concave profile defined by the interface cavity feature 125 of the lock arm 120.

In various embodiments, the interface protrusion feature 115 and the interface cavity feature 125 may define corresponding configurations such that the bump defined by the interface protrusion feature 115 is configured to be at least partially received within the concave groove defined by the interface cavity feature 125. For example, in various embodiments, the protrusion and cavity features 115, 125 collectively embody a homing feature that is configured to at least partially secure the arrangement of the interface protrusion feature 115 within the interface cavity feature 125 when the spool lock assembly 100 is in the unlocked configuration. The interface protrusion feature 115 and the interface cavity feature 125 may be configured to define a retention force therebetween representing a collective of one or more forces transmitting between the interface protrusion feature 115 and the interface cavity feature 125 that function to at least partially secure the interface protrusion feature 115 in a position within the interface cavity feature 125. In various embodiments, the interface protrusion feature 115 and the interface cavity feature 125 may be configured such that the retention force defined therebetween may at least partially secure (e.g., retain) the spool lock assembly 100 in the unlocked position by at least substantially counteracting the biasing force acting on the lock arm 120 from the biasing spring 123. For example, based at least in part on the configuration of the interface protrusion and cavity features 115, 125, the biasing spring 123 force acting on the lock arm 120 may be insufficient to cause the interface cavity feature 125 to disengage the interface protrusion feature 115 without one or more additional and/or external forces. For example, the spool lock assembly 100 may be configured such that, upon the latch plate 110 being arranged in the actuated position to selectively configure the spool lock assembly 100 in the unlocked configuration, the spool lock assembly 100 may be maintained in the unlocked position (e.g., the latch plate 110 may be help in the actuated position) until one or more additional and/or external forces, such as, for example, a user-generated force, an impact force, and/or the like, are imparted on the latch plate 110 to operably push the latch plate 110 in a direction toward the nominal position (e.g., pushing the first plate end 111 in an at least partially inward direction towards the tray 101).

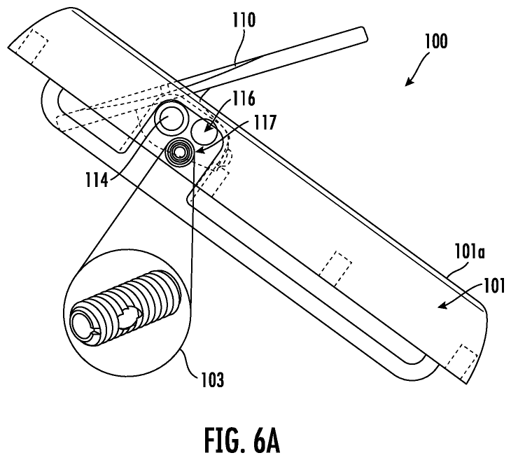

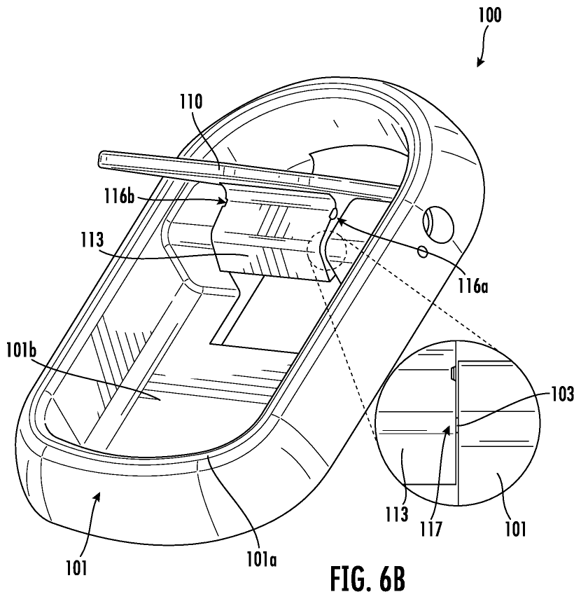

FIGS. 6A and 6B illustrate various views of an exemplary spool lock assembly in accordance with various embodiments described herein. In particular, FIGS. 6A and 6B illustrate a side cross-sectional view and a perspective view, respectively, of an exemplary spool lock assembly 100 configured to be held in the unlocked configuration using one or more ball plunger elements 103. In various embodiments, the spool lock assembly 100 may comprise one or more ball plunger elements 103 at least partially secured relative to the tray 101 (e.g., at outer sidewall 101a) and configured to define an interference between the tray 101 and an adjacent surface of the latch plate 110 when the latch plate 110 is positioned in one or more predetermined positions, such as, for example, the nominal position and/or the actuated position, to resist a rotational movement of the latch plate 110 away from that predetermined position. In various embodiments, a ball plunger 103 included in an exemplary spool lock assembly 100 may define a spring load that at least substantially continuously presses a metal bearing (not shown) defined by the ball plunger 103 against an adjacent portion of the latch plate 110 (e.g., a lateral side surface of the arm engagement tab 113).

As illustrated, the latch plate 110 may define one or more indentions, apertures, openings, and/or the like (e.g., indentions 116, 117) defined along the arm engagement tab 113 that are each configured to engage a ball plunger 103 by receiving at least a portion of the ball plunger 103 when the latch plate 110 is positioned in a corresponding position. For example, the ball plunger 103 may be defined by a spring-loaded ball element that is disposed within the cylindrical shell of the ball plunger 103 and biased (e.g., by a spring element disposed within the cylindrical shell) towards an open lateral end of the cylindrical shell facing in a direction towards the latch plate 110 (e.g., in an inward direction). At least a portion of the spring-loaded ball element may protrude through the open lateral end of the cylindrical shell such that the physical engagement of the ball plunger 103 with the latch plate 110 is defined by the portion of the ball element the open lateral end of the cylindrical shell physically contacting an adjacent surface of the latch plate 110. Based at least in part on the ball plunger 103 secured relative to a respective portion of the tray 101 being received within one of the indentions 116, 117, the ball plunger 103 may define an interference the opposes the rotation of the latch plate 110 away from the present position corresponding to the location of the engaged indention 116, 117. In various embodiments, the latch plate 110 having indentions 116, 117 defined along the lateral sides of the arm engagement tab 113 that are configured to receive a corresponding ball plunger 103 when the latch plate 110 is rotated to one or more predetermined positions may facilitate an at least temporary retention of the latch plate 110 in the predetermined position by causing an increase in the force required to move the latch plate 110 from said rotational position.

For example, in various embodiments, an exemplary spool lock assembly 100 may comprise a plurality of ball plungers 103, including a first and second ball plunger 103 secured relative to each of the lateral sides of the tray 101, respectively, in order to define two points of interference between the ball plungers 103 and respective lateral sides of the arm engagement tab 113. In such an exemplary configuration, as illustrated in FIG. 6B, the exemplary spool lock assembly 100 may include a latch plate 110 having a first set of indentions 116 (e.g., first indention 116a, second indention 116b) provided at respective lateral side surfaces of the arm engagement tab 113 that are configured to engage (e.g., receive) at least a portion of a respective one of the two ball plungers 103 when the latch plate 110 is positioned in the nominal position. In such an exemplary circumstance, the one or more balls plungers 103 may at least partially secure the position of the latch plate 110 relative to the tray 101 (e.g., the outer sidewall 101a) in order to at least temporarily maintain the latch plate 110 in the corresponding nominal position such that the spool lock assembly 100 is held in the locked configuration. Further, the latch plate 110 of the exemplary spool lock assembly 100 may define a second set of indentions 117 provided at respective lateral side surfaces of the arm engagement tab 113 that are configured to engage (e.g., receive) at least a portion of a respective one of the two ball plungers 103 when the latch plate 110 is positioned in the actuated position, as illustrated. In such an exemplary circumstance, the one or more balls plungers 103 may at least partially secure the position of the latch plate 110 relative to the tray 101 (e.g., the outer sidewall 101a) in order to at least temporarily maintain the actuated position of the latch plate 110 and hold the spool lock assembly 100 in the unlocked configuration.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A lifeline apparatus comprising:
a housing defining an interior portion configured for storing at least a portion of a retractable lifeline therein;
a spool lock assembly selectively configurable between a locked configuration and an unlocked configuration to facilitate a selective deployment of at least a portion of the retractable lifeline from within the housing, the spool lock assembly comprising:
a latch plate configurable between a nominal position and an actuated position based at least in part on a user interaction with at least a portion of the latch plate;
a lock arm at least partially engaged with the latch plate and configured for arrangement between an engaged position and a disengaged position based at least in part on a position of the latch plate, wherein the engaged position of the lock arm is defined by the lock arm being positioned to prevent the selective deployment of the lifeline from within the housing by restricting rotation of one or more components operatively connected to the at least a portion of the retractable lifeline;
wherein the configuration of the spool lock assembly between the locked configuration and the unlocked configuration is defined at least in part by the position of the latch plate between the nominal position and the actuated position.

2. The lifeline apparatus of claim 1, wherein the latch plate is hingedly connected to a latch hinge pin such that a movement of the latch plate between the nominal position and the actuated position is defined at least in part by a rotation of the latch plate about a central axis of the latch hinge pin.

3. The lifeline apparatus of claim 2, wherein the latch plate is physically engaged with the lock arm that the rotation of the latch plate between the nominal position and the actuated position corresponds to a respective rotation of the lock arm about a lock arm hinge to which the lock arm is pivotably connected.

4. The lifeline apparatus of claim 1, wherein the locked configuration of the spool lock assembly is defined at least in part by the lock arm being arranged in the engaged position.

5. The lifeline apparatus of claim 1, wherein the spool lock assembly further comprises a tray defined by an outer sidewall provided on an exterior surface of the housing and an interior tray portion defined within the outer sidewall, wherein the nominal position of the latch plate is defined at least in part by an exterior plate surface of the latch plate being arranged in an at least substantially flush configuration with at least a portion of the tray.

6. The lifeline apparatus of claim 1, wherein the spool lock assembly is configured such that, upon being configured in the unlocked position, the spool lock assembly is held in the unlocked configuration until a threshold locking force sufficient to cause the latch plate to be moved from the actuated position towards the nominal position is received at the latch plate.

7. The lifeline apparatus of claim 6, wherein the spool lock assembly comprises a plurality of corresponding interface features configured for engagement with one another to at least partially secure the latch plate in one or more directions relative to the lock arm to facilitate a retention of the latch plate and the lock arm in the actuated position and the disengaged position, respectively.

8. The lifeline apparatus of claim 7, wherein the plurality of corresponding interface features comprise an interface protrusion feature defined by the latch plate and an interface cavity feature defined by the lock arm, wherein, upon the spool lock assembly being configured in an unlocked configuration, the interface protrusion feature and the interface cavity feature physically contact one another such that the interface cavity feature receives at least a portion of the interface protrusion feature therein.

9. The lifeline apparatus of claim 8, wherein the interface protrusion feature is defined by a protrusion extending from an arm engagement tab of the latch plate, and the interface cavity feature is defined by a recessed groove provided along a first arm end defined by the lock arm, the recessed groove being configured to receive at least a portion of the protrusion therein to at least partially restrict a relative movement of the arm engagement tab with respect to the first arm end in one or more directions.

10. The lifeline apparatus of claim 6, further comprising one or more ball plungers to configured to facilitate a retention of the latch plate in one or more of the nominal position and the actuated position by engaging a surface of the latch plate to cause an interference between the latch plate and an adjacent surface of a tray of the spool lock assembly that operably resists a rotational movement of the latch plate away from one or more of the nominal position and the actuated position.

11. The lifeline apparatus of claim 10, wherein the latch plate defines one or more indentions provided at respective lateral side surfaces thereof is configured such that, when the latch plate is positioned in one or more of the nominal position and the actuated position, the latch plate is configured to receive at least a portion of the one or more ball plungers within the one or more indentions, wherein the one or more ball plungers being at least partially disposed within the one or more indentions at least partially secures the latch plate relative to the adjacent surface of the tray to resist a relative movement of the latch plate away from the adjacent surface of the tray.

12. The lifeline apparatus of claim 11, wherein the one or more ball plungers comprises a first ball plunger disposed between a first lateral side surface of the latch plate and a first lateral side surface of the tray adjacent thereto, and a second ball plunger disposed between an opposing second lateral side surface of the latch plate and a second lateral side surface of the tray adjacent thereto, wherein the one or more indentions defined by the latch plate comprises a first indention provided along the first lateral side surface and configured to receive at least a portion of the first ball plunger therein when the latch plate is positioned in the actuated position, and a second indention provided along the second lateral side surface and configured to receive at least a portion of the second ball plunger therein when the latch plate is positioned in the actuated position.

13. The lifeline apparatus of claim 1, wherein the spool lock assembly further comprises a secondary safety mechanism that configured for selective arrangement in a locked position such that the spool lock assembly defines a secondary locking means for securing the latch plate in the nominal position

14. The lifeline apparatus of claim 13, wherein the secondary safety mechanism defines a dynamic configuration relative to the latch plate, wherein the secondary safety mechanism is selectively configurable between the locked position and an unlocked position based at least in part on one or more movements of the secondary safety mechanism relative to the latch plate.

15. The lifeline apparatus of claim 14, wherein the spool lock assembly is configured such that configuring the spool lock assembly in the unlocked configuration is defined by a dual-action unlocking operation.

16. The lifeline apparatus of claim 16, wherein the dual-action unlocking operation is defined by a first arrangement of the secondary safety mechanism in an unlocked position and a second arrangement of the latch plate in the actuated position.

17. The lifeline apparatus of claim 1, wherein the spool lock assembly further comprises a biasing spring engaged with the lock arm and configured to apply one or more bias forces to the lock arm to bias a rotation thereof towards the locked position.

18. The lifeline apparatus of claim 17, wherein at least a portion of the lock arm is in physical contact with an arm engagement tab provided along an underside of the latch plate such that a biased configuration of the lock arm causes the latch plate to be biased towards the nominal position.

19. The lifeline apparatus of claim 1, further comprising a first fastener element fixedly secured to an exterior surface of the housing and a second fastener element attached to a distal end of the retractable lifeline.

20. The lifeline apparatus of claim 1, wherein the actuated position of the latch plate is defined at least in part by at least a portion of the latch plate protruding outward in a direction at least partially away from an exterior surface of the housing.
